(19) United States
(12) Patent Application Publication
(10) Pub. No.: US 2008/0042496 A1
(43) Pub. Date: Feb. 21, 2008

(54) Electromagnetic power transferring system

(76) Inventor: Chyi-Ming Chiou, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/526,623

(22) Filed: Sep. 26, 2006

(30) Foreign Application Priority Data
Aug. 18, 2006 (TW) 095130552

(51) Int. Cl. H02K 7/18; H02K 41/00

(52) U.S. Cl. 310/15; 310/12; 290/1 A

(57) ABSTRACT

An electromagnetic power transferring system includes a transmission apparatus and at least a power generator having a crank shaft, a connecting rod, a generation assembly, and an electricity storage and controlling device which is connected with an electricity system and able to switch, generate and store electricity. The generation assembly includes a hollow carrier and an inner carrier, the hollow carrier having at least an opening and being wound about inducing coils, one end of the inducing coils connected to the electricity system, the inner carrier being of magnetism and sliding within the hollow carrier through the opening. An induction magnetic field is created by providing electrical current to the inducing coils and further generates induction current to drive the transmission apparatus whereby to perform a reciprocal movement, which enables the electromagnetic power transferring system to produce and store electricity and transfer power.

### BACKGROUND OF THE INVENTION

1. Field of the Invention

The present invention relates to a power transferring system, and particularly to an electromagnetic power transferring system utilizing electromagnetic force to produce a reciprocal movement and further generate induction current for producing and storing electricity, whereby to maintain motivity in return for the reciprocal movement and to transfer power.

2. Related Art

Piston mechanisms transfer power by linear reciprocation movement for many machines like engines, internal combustion machines, superchargers and so on. The piston mechanism is designed to be able to bear successive pressure resulting from fluids (gases or liquids) being compressed, by which the linear reciprocation movement can keep going on. In the process of the movement, fuel is supplied nonstop through a fuel system and is a source of maintaining continuous power to the machines. The substantial fuel consumption for actuating the machines may result in environmental or natural resources protection problems.

As is well-known, oil prices keep soaring due to unstable international situations and limited resources. The high price and low storage of oil have caused many negative effects on the earth. As a result, a variety of substitutes have been researched and developed into effective and economical power. Solar power is the most successful new energy, which can be converted and then generate electricity that can reduce oil consumption. Accordingly, using electricity as power instead of fuel for piston mechanisms is also necessary and important which can improve the earth environment and economize fuel consumption.

### SUMMARY OF THE INVENTION

Accordingly, an object of the present invention is to provide an electromagnetic power transferring system, which generates induction magnetic field by providing electrical current to inducing coils to perform a reciprocal movement whereby to produce and store electricity, and further providing motivity in return for the reciprocal movement and transferring power.

To achieve the above-mentioned object, the electromagnetic power transferring system includes a transmission apparatus and at least a power generator having a crank shaft pivotally mounted on the transmission apparatus, a connecting rod pivotally connected to the crank shaft, a generation assembly pivotally coupled with the connecting rod, and an electricity storage and controlling device connecting with an electricity system and operating synchronously with the transmission apparatus.

A feature of the present invention is that the generation assembly includes a hollow carrier and an inner carrier, the hollow carrier having at least an opening and being wound about inducing coils, one end of the inducing coils connected to the electricity system, the inner carrier being of magnetism and sliding within the hollow carrier through the opening.

Another feature of the present invention is that the electricity storage and controlling device is able to switch electricity provided by the electricity system and generate and store electricity.

### BRIEF DESCRIPTION OF THE DRAWINGS

FIG. 1 is a front elevation view of a first embodiment of an electromagnetic power transferring system of the present invention;

FIG. 2 shows a rotation wheel and a power switch means of FIG. 1 on which a casing is taken off;

FIGS. 3 to 6 are schematic views illustrating relation between the rotation wheel and the power switch means;

FIGS. 7 to 10 are schematic views illustrating an interaction relation between a crank shaft, a connecting rod, and a generation assembly;

FIG. 11 is a second embodiment of the present invention.

### DESCRIPTION OF THE PREFERRED EMBODIMENTS

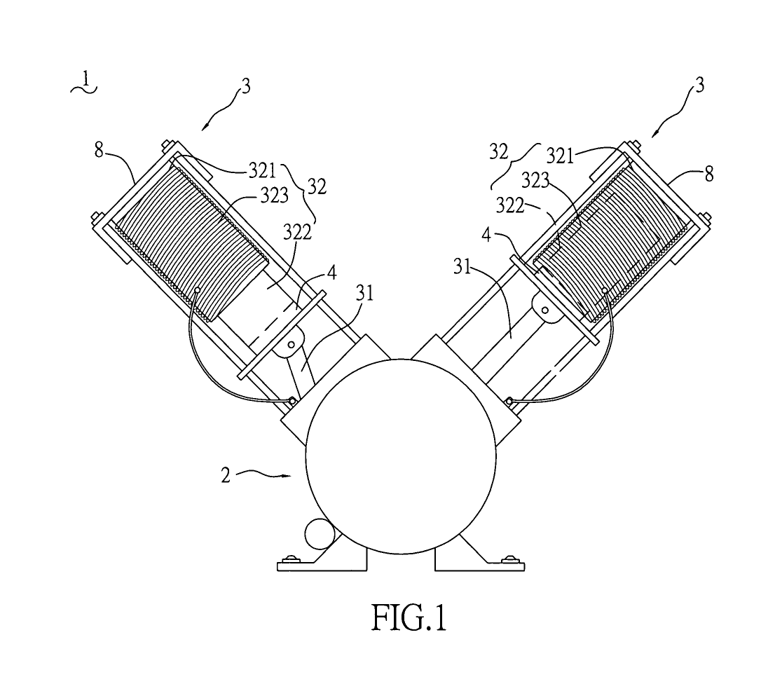

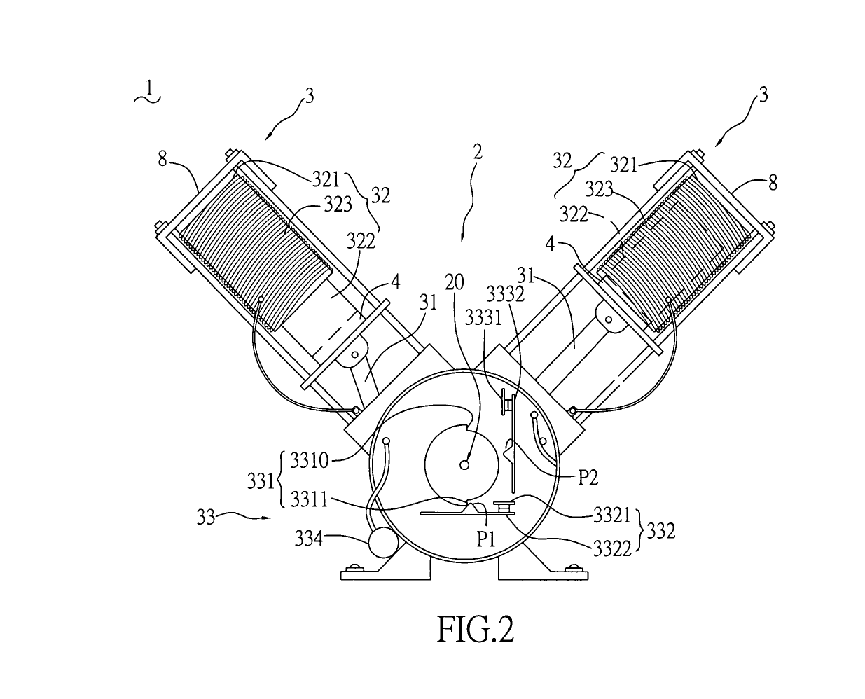

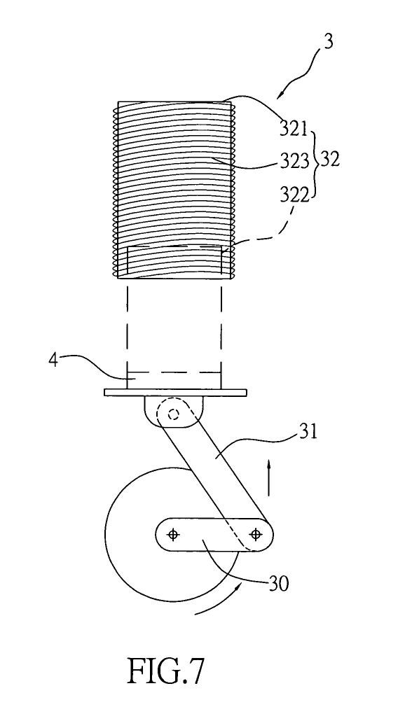

Referring to FIGS. 1 and 2, a front elevation view of a first embodiment of an electromagnetic power transferring system 1 of the present invention, the electromagnetic power transferring system 1 includes: a transmission apparatus 2 and two sets of power generator 3 (quantity can be increased), wherein art of the transmission apparatus 2 has been disclosed in conventional invention; therefore, there is no detail description of that art hereafter. Each power generator 2 includes a crank shaft 30 (as shown in FIG. 7), a connecting rod 31, a generation assembly 32 and an electricity storage and controlling device 33, wherein the crank shaft 30 is pivotally mounted on a transmission shaft 20 of the transmission apparatus, and the connecting rod 31 is pivotally connected to the crank shaft 30.

The generation assembly 32 pivotally coupled with the connecting rod 31 includes a hollow carrier 321 and an inner carrier 322, wherein one end of the hollow carrier 321 is open towards the inner carrier 322, and another end thereof is fixed on a supporting frame 8. The hollow carrier 321 is wound about inducing coils 323, wherein one end of the inducing coils is connected with negative pole of an electricity system (not shown), another end thereof is connected with an extern electricity system (not shown). The inner carrier 322 is sliding within the hollow carrier 321 and has a magnet 4 (or another permeability material) thereon in order to be magnetized. A polarity of the magnet 4 is in polar attraction to a magnetic field generating by the inducing coils 323, that is, opposite poles attract.

The electricity storage and controlling device 33 connected with the electricity system and operated synchronously by the transmission apparatus 2 includes a rotation wheel 331, a power switch means 332, 333, and a accumulating unit 334, wherein the rotation wheel 331 has bulges 3310, 3311, the bulges 3310, 3311 forming a flange 3312 by protruding from peripheral edges of the rotation wheel 331 and rounding half of it. The power switch means 332, 333, in this embodiment, are respectively disposed in perpendicular to each other and respectively have two contact plates 3321, 3322 and 3331, 3332. Each pair of contact plates 3321, 3322 and 3331, 3332 are opposite to each other and cantileverly contact each other in normally close state, wherein the contact plates 3322, 3332 have a projection P1, P2, respectively, for propping against the bulge 3310, 3311 in order to be dissociated from the opposite contact plates 3321, 3331. The accumulating unit 334 is a capacitor used for storing electricity.

Accordingly, when electrical current flows through the inducing coils 323 and therefore generate a magnetic field due to electromagnetic effects, the inner carrier 322 can reciprocates continuously within the hollow carrier 321. Furthermore, induction current is generated because of relative inertia movement between the hollow carrier 321 and the inner carrier 322 and can be restored in the accumulating unit 334 when the electricity current of the inducing coils 323 is cut off. The restored current can be supplied as electricity to the inducing coils 323.

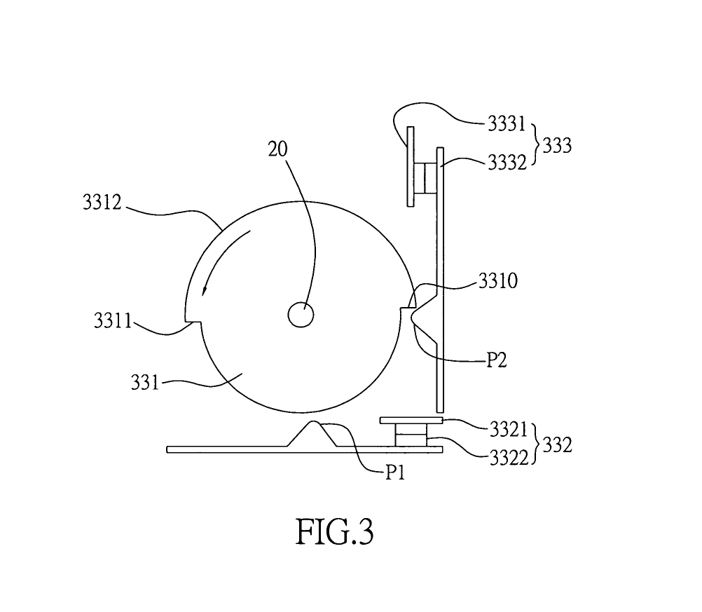

Please refer to FIGS. 3 to 6 and FIGS. 7 to 10, which are schematic views illustrating relation between the rotation wheel 331 and the power switch means 332, 333 during a process of the rotation wheel 331 rotating, and an interaction relation between the rotation process and the crank shaft 30, the connecting rod 31 and generation assembly 32.

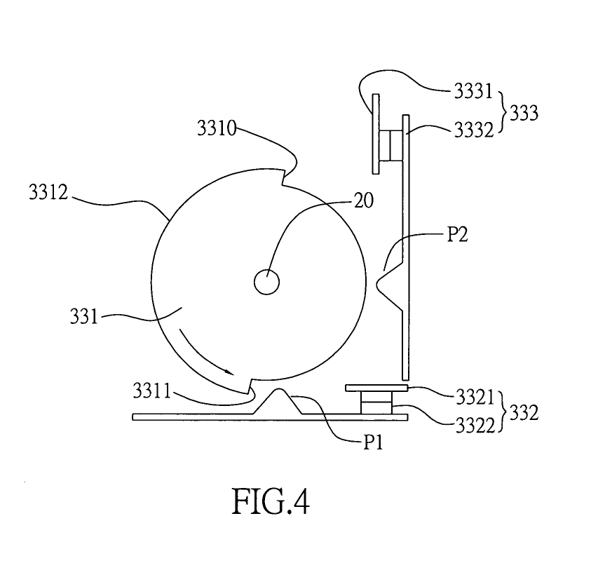

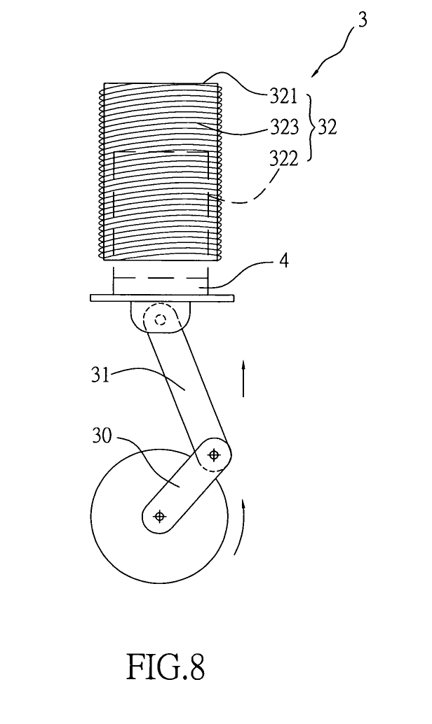

First, referring to FIGS. 3 and 4 in combination with FIGS. 7 and 8, the inducing coils 323 are electrified when the power switch means 332, 333 are not yet being propped by the rotation wheel 331(as shown in FIG. 3) Meanwhile, the inner carrier 322 is pulled up due to affection of opposite poles attraction (as shown in FIGS. 7 and 8), which synchronously impels the crank shaft 30 to rotate and further rotates the connecting rod 31, therefore, the inner carrier 322 can perform linear reciprocation movement. As a result, the transmission shaft 20 of the transmission apparatus 1 is being rotated, which also impels the rotation wheel 331 to rotate. The linear reciprocation movement of the inner carrier 322, because opposite poles attract, keeps going on until the bulge 3311 is propped against the projection P1, and during reciprocation movement electrical current keeps flowing through the inducing coils 323.

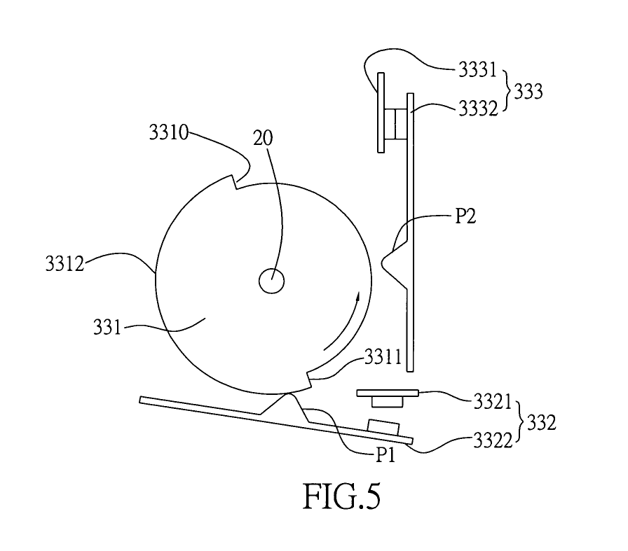

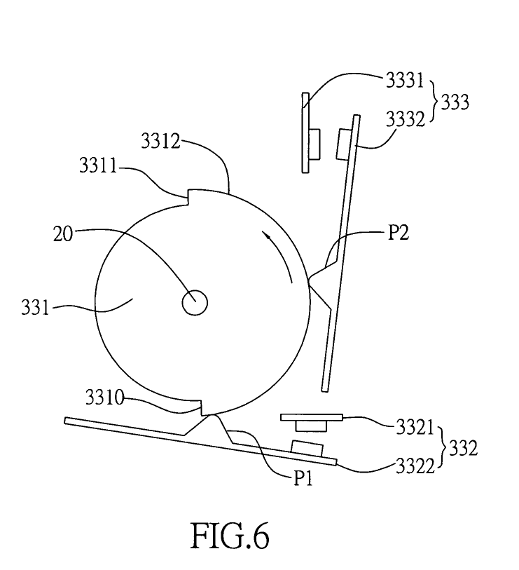

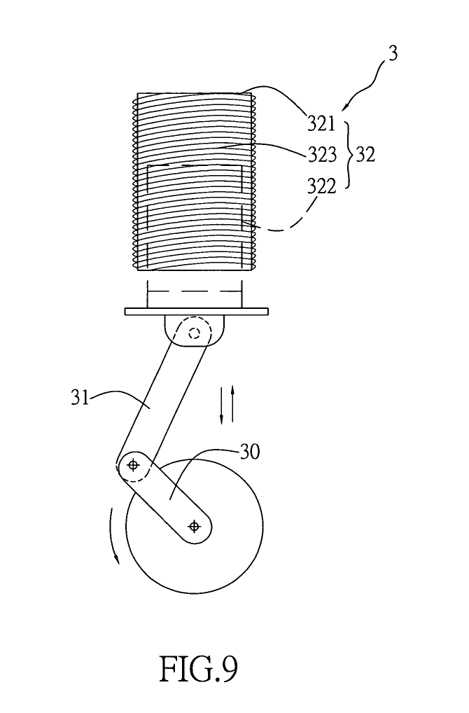

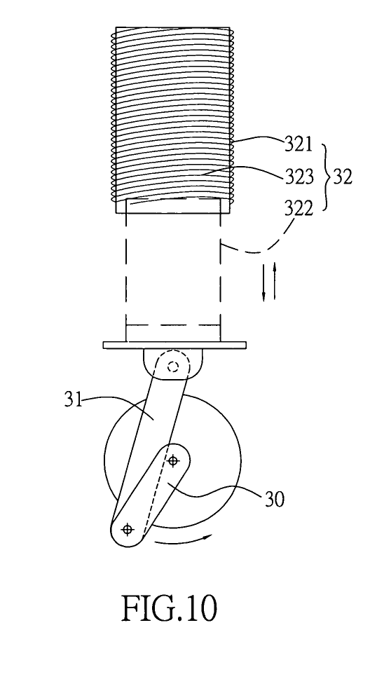

Please refer to FIGS. 5 and 6 in combination with FIGS. 9 and 10. When the bulge 3311 is propped against the projection P1, the contact plate 3322 is dissociated from the contact plate 3321, and the inducing coils 323 wound about one set of the power generators 3 are in a state of electricity cut off. At the same time, the induction current is generated because of relative inertia movement between the hollow carrier 321 and the inner carrier 322 and can be restored in the accumulating unit 334 (as shown in FIGS. 9 and 10). Meanwhile, on the other hand, the inducing coils 323 wound about another set of the power generator 3 are in a state of galvanization, which will not be changed to be electricity cut off until the bulge 3310 is propped against the projection P2, and the contact plate 3322 is dissociated from the contact plate 3321 (as shown in FIG. 6). Likewise, the induction current is generated and can be restored in the accumulating unit 334 because of relative inertia movement between the hollow carrier 321 and the inner carrier 322. Particularly, when the flange 3312 of the rotation wheel 331 rotates against both the projections P1, P2, the two sets of power generator 3 both are in a state of accumulating electricity. The state of accumulating electricity keeps on until the bulge 3310 is dissociated from the projection P1. Accordingly, an interchange process of galvanization and electricity cut off goes on and provide uninterrupted electricity for the reciprocation movement whereby to transfer power to applied productions and to economize energy consumption.

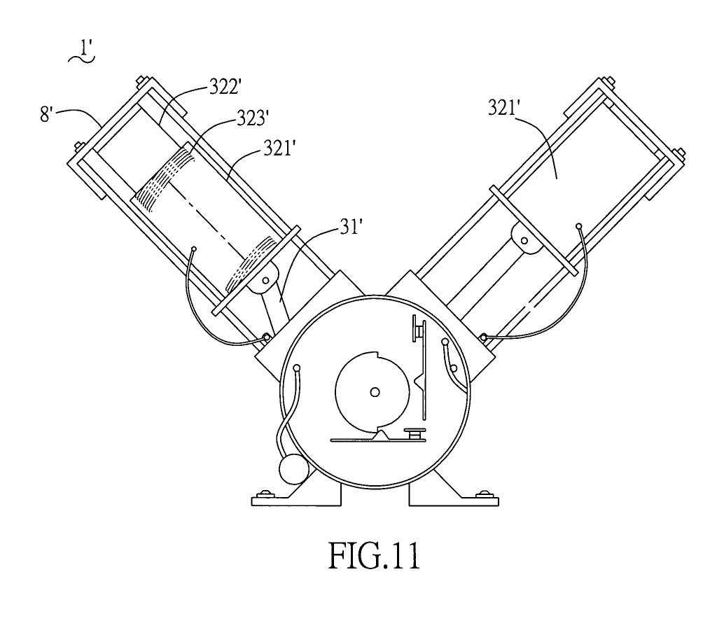

Furthermore, please refer to FIG. 11 illustrating an elevation view of a second embodiment of an electromagnetic power transferring system 1′ of the present invention. The differences between the first and second embodiments are the inner carrier 322′ being fixed to the supporting frame 8′, and the hollow carrier 321′ being sliding over the inner carrier 322′ and mounted on one end of the connecting rod 31′, whereby, the interchange process of galvanization and electricity cut off is also able to keep going on, and same functions as the first embodiment are provided as well.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. An electromagnetic power transferring system connecting with a circuit system, comprising:
a transmission apparatus including at least a power generator having:
a crank shaft pivotally mounted on the transmission apparatus;
a connecting rod pivotally connected to the crank shaft;
a generation assembly pivotally coupled with the connecting rod; and
an electricity storage and controlling device connecting with an electricity system and operating synchronously with the transmission apparatus, wherein
the generation assembly comprises a hollow carrier and an inner carrier, the hollow carrier having at least an opening and being wound about inducing coils, one end of the inducing coils connected to the electricity system, the inner carrier sliding within the hollow carrier through the opening and being of magnetism, whose magnetic field direction corresponds to direction of magnetic field of the inducing coils;
the electricity storage and controlling device being able to switch electricity provided by the electricity system and to generate and store electricity.

2. The electromagnetic power transferring system as claimed in claim 1, wherein a magnet is disposed on the inner carrier for magnetizing the inner carrier.

3. The electromagnetic power transferring system as claimed in claim 1, wherein a magnet and a permeability material are disposed on the inner carrier for magnetizing the inner carrier.

4. The electromagnetic power transferring system as claimed in claim 2, wherein magnetic field direction of the inner carrier and magnetic filed of the inducing coils are in polar opposition or attraction to each other (like poles repel or opposite poles attract).

5. The electromagnetic power transferring system as claimed in claim 1, wherein the inner carrier is mounted on one end of the connecting rod, and the hollow carrier is fixed on a supporting frame.

6. The electromagnetic power transferring system as claimed in claim 1, wherein the hollow carrier is mounted on one end of the connecting rod, and the inner carrier is fixed on a supporting frame.

7. The electromagnetic power transferring system as claimed in claim 1, wherein two sets of the power generator are respectively disposed at different horizontal angle within 0 to 180 degree.

8. The electromagnetic power transferring system as claimed in claim 1, wherein the electricity storage and controlling device comprises a rotation wheel having at least a bulge, at least a power switch means being actuated by the bulge of the rotation wheel wherein one end of the power switch means connects with the electricity system, and another end thereof connects with the inducing coils, an accumulating unit connecting with the electricity system for accumulating electricity.

9. The electromagnetic power transferring system as claimed in claim 1, wherein the power switch means includes two contact plates being opposite to each other and cantileverly contacting each other in normally close state, wherein one of the contact plates has a projection for propping against the bulge to be dissociated from the opposite contact plate.

10. The electromagnetic power transferring system as claimed in claim 8, wherein the accumulating unit is a capacitor.
